(19) United States
(12) Patent Application Publication
(10) Pub. No.: US 2021/0363008 A1
(43) Pub. Date: Nov. 25, 2021

(54) PROCESS FOR PREPARING A STABILIZED AQUEOUS HYDROGEN PEROXIDE SOLUTION

(71) Applicant: Evonik Corporation, Parsippany, NJ (US)

(72) Inventor: Gregory Melenkevitz, Union, NJ (US)

(73) Assignee: Evonik Corporation, Parsippany, NJ (US)

(21) Appl. No.: 17/057,952

(22) PCT Filed: Aug. 1, 2019
(86) PCT No.: PCT/US2019/044649

§ 371 Date: Nov. 23, 2020

Related U.S. Application Data
(60) Provisional application No. 62/713,746, filed on Aug. 2, 2018.

(51) Int. Cl. C01B 15/037; C01B 15/023; C01B 15/013; B01D 61/02; B01D 11/04

(52) U.S. Cl. CPC C01B 15/037; C01B 15/023; B01D 11/0492; B01D 61/025; C01B 15/013

(57) ABSTRACT

In a process for preparing hydrogen peroxide by an anthraquinone process, comprising hydrogenating a working solution comprising an anthraquinone compound, oxidizing the hydrogenated working solution to form hydrogen peroxide and extracting the hydrogen peroxide with water, the extracted aqueous hydrogen peroxide solution is stabilized with one or more oxidizer stable polymeric stabilizers.

### CROSS REFERENCE TO RELATED APPLICATIONS

This application is a 35 U.S.C. § 371 U.S. national phase entry of International Application No. PCT/US2019/044649 having an international filing date of Aug. 1, 2019, which claims the benefit of U.S. Provisional Application No. 62/713,746 filed Aug. 2, 2018, both of which are incorporated herein by reference in its entirety.

### FIELD

The present invention relates to a process for preparing polymer-stabilized aqueous solutions of hydrogen peroxide.

### BACKGROUND

Hydrogen peroxide has a variety of industrial uses, as summarized in Table 1.

TABLE 1

| Industry | Application |
|---|---|
| Pulp and paper | Bleaching wood pulp |
| Mining | Detoxification of cyanide tailings |
| Textile bleaching | Bleaching of cotton fabrics |
| Wool scouring | Bleaching of wool |
| Waste water treatment | Measuring dissolved oxygen. Destroying |
| | soluble cyanides, sulfides, and phenols. |
| Packaging | Aseptic packaging of milk and fruit juice |

Today, the vast majority of hydrogen peroxide is produced by the anthraquinone process. A survey of the anthraquinone process and its numerous modifications is given in G. Goor, J. Glenneberg, S. Jacobi: “Hydrogen Peroxide” Ullmann's Encyclopedia of Industrial Chemistry, Electronic Release, 6th ed. Wiley-VCH, Weinheim June 2000, page 14. Generally, the anthraquinone loop process comprises the following steps:
(a) Hydrogenation of a working solution comprising an organic solvent or mixture of organic solvents, and one or more active anthraquinone compounds;
(b) oxidation of the hydrogenated working solution to form hydrogen peroxide;
(c) extraction of hydrogen peroxide with water;
(d) stabilizing of the extracted aqueous hydrogen peroxide solution;
(e) drying of the working solution after extraction; and
(f) regeneration and purification of the working solution.

For each of the above distinct process steps, the Ullmann reference discloses different possibilities.

Crude hydrogen peroxide solutions or concentrated hydrogen peroxide solutions obtained from the anthraquinone process contain a plurality of compounds in addition to hydrogen peroxide in low concentrations. These compounds are either impurities or additives like stabilizers. The impurities are compounds that are extracted from the working solution into the aqueous phase.

They are mainly ionic or polar species like carboxylic acids, alcohols, carbonyl compounds and amines. These impurities are therefore also found in commercial hydrogen peroxide solutions.

For example, hydroquinone solvents that are commonly used in the above described process are nitrogen containing compounds like amides and ureas (see Ullmann supra page 6). Examples include tetraalkyl ureas like tetrabutyl urea. The use of these solvents results in amine impurities like monoalkyl or dialkyl especially monobutyl and dibutyl amines in the final hydrogen peroxide solutions. For example, the commercial hydrogen peroxide solution may contain up to 200 ppm mono- and dibutyl amine based on the weight of hydrogen peroxide.

Ionic components, especially phosphates and nitrates, are added to commercially available aqueous hydrogen peroxide solutions as stabilizers to reduce hazardous decomposition of hydrogen peroxide.

There is a need for improved processes for obtaining stabilized hydrogen peroxide solutions with reduced amounts of phosphate and reduced formation of scale during the manufacturing process.

### SUMMARY

The invention provides improved stability in the production of hydrogen peroxide. Sodium acid pyrophosphate is used in the manufacturing process to stabilize the hydrogen peroxide solution prior to it being concentrated. The phosphate controls metal decomposition of the hydrogen peroxide solution. The present invention provides an oxidizer stable polymeric stabilizer that allows passivation of metal surfaces to prevent trace metals from leaching into the hydrogen peroxide liquid as well as stabilizing the metals that are associated with the process. By controlling trace metal contamination, less inorganic phosphate stabilizer can be used, reducing the sodium content in the finished peroxide. A further advantage of the process is the prevention of iron phosphate scale in the concentrator as well as less decomposition of the peroxide in the concentrator, thereby increasing yield.

This inventive aqueous hydrogen peroxide solution can be obtained by a process for the preparation of the hydrogen peroxide solution according to the anthraquinone loop process comprising:
i) hydrogenating a working solution comprising an organic solvent and one or more active anthraquinone compounds;
ii) oxidizing the hydrogenated working solution to form hydrogen peroxide,
iii) extracting the hydrogen peroxide with water, and
iv) stabilizing the extracted aqueous hydrogen peroxide solution with one or more oxidizer stable polymeric stabilizers.

### BRIEF DESCRIPTION OF THE DRAWINGS

FIG. 1 shows a representative process of preparing stabilized hydrogen peroxide solutions.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

For the recitation of numeric ranges herein, each intervening number there between with the same degree of precision is explicitly contemplated. For example, for the range 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9 and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

Concentrations and fractions given in “%” and “ppm” refer to weight unless specified otherwise.

Hydrogen Peroxide Production

Hydrogen peroxide is manufactured using the anthraquinone process. This process is a cyclic operation where the alkyl anthraquinone is reused. The synthesis loop includes sequential hydrogenation, filtration, oxidation and extraction stages.

The expression “alkylanthraquinone process” is intended to denote a process for producing an aqueous hydrogen peroxide solution which includes subjecting a working solution of at least one alkylanthraquinone and/or of at least one tetrahydroalkylanthraquinone to a hydrogenation step, in a diluent, to produce one or more alkylanthrahydroquinones and/or alkyltetrahydroanthraquinones. The working solution leaving the hydrogenation step is then subjected to an oxidation with oxygen, air or oxygen-enriched air to give hydrogen peroxide and to reform the alkylanthraquinones and/or alkyltetrahydroanthraquinones. The hydrogen peroxide formed is then separated from the working solution by means of an extraction step, for example using water, the hydrogen peroxide being recovered in the form of a crude aqueous hydrogen peroxide solution. The working solution leaving the extraction step is then recycled into the hydrogenation step in order to recommence the hydrogen peroxide production cycle.

The term “alkylanthraquinones” is intended to denote, for example, 9,10-anthraquinones substituted in position 1, 2 or 3 with at least one alkyl side chain of linear or branched aliphatic type comprising at least one carbon atom. These alkyl chains usually comprise less than 9 carbon atoms and preferably less than 6 carbon atoms. Examples of such alkylanthraquinones are 2-ethylanthraquinone, 2-isopropylanthraquinone, 2-sec- and 2-tert-butylanthraquinone, 1,3-, 2,3-, 1,4- and 2,7-dimethylanthraquinone, and 2-iso- and 2-tert-amylanthraquinone, and mixtures of theses quinones. The term “alkyanthrahydroquinones” is intended to denote the 9,10-hydroquinones corresponding to the 9,10-alkyanthraquinones specified above.

In the hydrogenation step, an alkyl anthraquinone may be dissolved in two solvents, one nonpolar and the other polar. Collectively the anthraquinone and solvents are called the working solution. This working solution is recycled.

The hydrogenation is a demanding step in the anthraquinone process. High activity and high selectivity are required of the hydrogenation catalyst. The conversion and selectivity of the reaction in the hydrogenation step are dependent on the partial pressure of hydrogen, the temperature, the concentrations of the reacting components, the catalyst, and the flow conditions in the reactor. Secondary reactions may decrease the quantity of the anthraquinone derivatives which produce hydrogen peroxide. Both suspension reactors and fixed-bed reactors have been used for the hydrogenation.

The working solution containing the dissolved anthraquinone can be hydrogenated using hydrogen gas in a slurry-type hydrogenator using alumina loaded with a small amount of catalyst (e.g., palladium). The suspended catalysts used have included porous so-called palladium black, palladium absorbed into a carrier (for example alumina, activated carbon), and Raney nickel. The porous catalyst is suspended and the hydrogen is dispersed into the working solution in, for example, a mixing-tank reactor or a tubular reactor. In a tubular reactor the mixing is affected by the high linear velocity of the working solution. Usually the linear velocities are over 3 m/s and below 10 m/s in an open tube (U.S. Pat. No. 4,428,923). Mixing has also been improved by using as a reactor tube an alternately converging and expanding tube (U.S. Pat. No. 3,423,176).

Temperature of hydrogenation is controlled to around 40-60° C. (e.g., 45° C.) and the reactor is agitated to ensure good mixing of catalyst with working solution and hydrogen. During hydrogenation, the alkylanthraquinone is converted to both the alkylanthrahydroquinone and the tetrahydroalkyl-anthrahydroquinone, although production of the tetra-form of the quinone is preferred because it can be more easily hydrogenated. The hydrogenation stage is carefully controlled to avoid over-hydrogenation of the anthraquinone rings. Basicity and moisture content are important for optimum catalyst and activity.

The working solution that now contains hydrogenated anthraquinone may be filtered to remove any trace levels of catalyst. If the catalyst is not removed then it will decompose the hydrogen peroxide in later stages, reducing yields and causing potential hazards.

The contact surfaces and contact periods of the catalyst, the working solution and the hydrogen gas are important for the hydrogenation reaction. By using a stationary, solid catalyst in the hydrogenation the contact period in the catalyst reaction can be shortened, whereby the proportion of secondary reactions is decreased. The absence of the expensive filtration step can be a significant advantage of using a fixed catalyst bed rather than a suspended catalyst.

The working solution may be oxidized by blowing oxygen or air through it. The tetrahydroalkylanthrahydroquinone is oxidized, forming hydrogen peroxide in an organic phase. No catalyst is used and hence this step is often referred to as auto-oxidation.

Since the hydrogen peroxide is present in an organic phase and the product is required in aqueous phase, water is added to the top of a liquid-liquid extraction column. The water flows down the column over perforated trays while the working solution is pumped up the column. The extractor design and operation ensures a maximum contact of water with the working solution. The water reaches the bottom of the extractor and contains about 25-40% w/w crude hydrogen peroxide, whilst the working solution that leaves the top of the extractor is free of hydrogen peroxide and is pumped back to the hydrogenator. This working solution now contains the original alklyanthraquinone and tetrahydroalkylanthraquinone.

The aqueous hydrogen peroxide solution produced according to the invention has a hydrogen peroxide concentration [H₂O₂] expressed as % by weight of the solution. The crude hydrogen peroxide may be vacuum distilled to concentrations of up to 70% w/w. The hydrogen peroxide solution may be concentrated to a hydrogen peroxide concentration of at least 50% by weight, at least 60% by weight, or from 60 to 70% by weight, based on the total weight of the hydrogen peroxide solution. Alternatively, the hydrogen peroxide concentration may be 80% or less, 75% or less, or 60% or less. The hydrogen peroxide concentration [H₂O₂] is in general at least 5%, in particular at least 10%, in many cases equal to or more than 20%, or equal to or even more than 30%. Concentrations of at least 32%, at least 35%, at least 38%, are usual. For example, hydrogen peroxide concentrations of around 40% or 50% are common.

In aspetic packaging applications, H₂O₂ concentrations are typically about 35%. For example, the hydrogen peroxide concentration may be 35.0 to 36.0% or 34.0 to 34.9%. Hydrogen peroxide concentrations used for pulp and paper bleaching are typically lower, e.g., about 0.1-5%. In the case of bleaching kraft pulp, the concentration may be around 0.1-1%. In the case of a chemi-thermomechanical pulp, the concentration may be around 1-5%. 50-70% aqueous H₂O₂ solutions produced according to the disclosed methods may be diluted to appropriate concentrations according to the particular use.

The concentrated hydrogen peroxide product is stabilized against unwanted decomposition by adding the one or more polymeric stabilizers described herein and optionally other stabilizers as described below. For example, one or more polymeric stabilizers may be added after aqueous extraction of hydrogen peroxide from the working solution.

Depending on the final use of the hydrogen peroxide solutions, purification steps may be conducted in order to obtain the required specification for the respective use of the hydrogen peroxide solution. For example, food and electronics grade hydrogen peroxide solutions require higher purity levels than solutions intended for use in pulp and paper bleaching. U.S. Pat. No. 6,939,527 discloses a purification process for aqueous hydrogen peroxide solutions, whereby the solutions are treated with an anion exchange resin, a nonionic absorbing resin having a specific structure, and a neutral absorbing resin also having a specific macroporous structure. The hydrogen peroxide solutions obtained in this way are substantially free of cationic, anionic and organic impurities. Therefore, the solutions are particularly useful in microelectronics applications.

Similarly U.S. Pat. No. 4,999,179 discloses a process for purification of hydrogen peroxide solutions that contain after purification each metal cation in an amount of less than 5 ppb, each anion in an amount of less than 10 ppb and organic impurities in an amount of not more than 5 ppm in terms of total organic carbon content.

In some embodiments, the crude aqueous hydrogen peroxide solution obtained from the alkylanthraquinone process can be further subjected to at least one subsequent purification step. The subsequent purification step can consist of any method which is well known to those skilled in the art for reducing the impurity content of an aqueous hydrogen peroxide solution. A type of purification step which can be employed is a washing operation with at least one organic solvent, as the one described in European patent application EP 0965562. This document is incorporated herein by reference. Other purification techniques include reverse osmosis, microfiltration, ultrafiltration, nanofiltration, ion exchange resin treatment, nonionic absorber resin treatment, and neutral absorber resin treatment, as described in U.S. Pat. Nos. 8,715,613, 6,333,018, 5,215,665, 5,232,680, 6,939,527, 4,999,179, 4,879,043, 3,297,404, 3,043,666, EP552187, EP0930269, WO2005/033005, and Abejon et al., Separation and Purification Technology (2010) 76, 44-51, which are hereby incorporated by reference.

Microfiltration (MF) removes particles in the range of approximately 0.1-1 μm. In general, suspended particles and large colloids are rejected while macromolecules and dissolved solids pass through the MF membrane. Applications include removal of bacteria, flocculated materials, or TSS (total suspended solids). Transmembrane pressures are typically 10 psi (0.7 bar).

Ultrafiltration (UF) provides macro-molecular separation for particles ranging in size from approximately 20-1,000 Angstroms (up to 0.1 μm). All dissolved salts and smaller molecules pass through the membrane. Items rejected by the membrane include colloids, proteins, microbiological contaminants, and large organic molecules. Most UF membranes have molecular weight cut-off values between 1,000 and 100,000 g/mol. Transmembrane pressures are typically 15-100 psi (1-7 bar).

Nanofiltration (NF) refers to a membrane process which rejects particles in the approximate size range of 1 nanometer (10 Angstroms), hence the term “nanofiltration.” NF operates in the realm between UF and reverse osmosis. Organic molecules with molecular weights greater than 200-400 g/mol are rejected. Also, dissolved salts are rejected in the range of 20-98%. Salts which have monovalent anions (e.g., sodium chloride or calcium chloride) have rejections of 20-80%, whereas salts with divalent anions (e.g., magnesium sulfate) have higher rejections of 90-98%. Typical applications include removal of color and total organic carbon (TOC) from surface water, removal of hardness or radium from well water, overall reduction of total dissolved solids (TDS), and the separation of organic from inorganic matter in specialty food and wastewater applications. Transmembrane pressures are typically 50-225 psi (3.5-16 bar).

Reverse osmosis (RO) membranes generally act as a barrier to all dissolved salts and inorganic molecules, as well as organic molecules with a molecular weight greater than approximately 100 g/mol. Water molecules, on the other hand, pass freely through the membrane creating a purified product stream. Rejection of dissolved salts is typically 95% to greater than 99%, depending on factors such as membrane type, feed composition, temperature, and system design.

Aqueous hydrogen peroxide solutions may be subjected to one or more of the foregoing purification techniques or sequentially subjected to the same purification technique more than once to achieve higher levels of purity. For example, for food grade hydrogen peroxide solutions, reverse osmosis purification may be carried out at least once (e.g., 1-2 times). For electronics grade hydrogen peroxide solutions reverse osmosis may be carried out at least twice (e.g., 2-3 times). Standard grade hydrogen peroxide refers to hydrogen peroxide solutions having higher concentrations of residue upon evaporation and that would not be suitable for food or electronics applications. In some embodiments, standard grade solutions have not undergone treatment by techniques such as reverse osmosis. In some embodiments, standard grade hydrogen peroxide is a solution remaining that did not pass a reverse osmosis membrane.

In some embodiments, the aqueous hydrogen peroxide solution is subjected to reverse osmosis followed by stabilizing with the one or more oxidizer stable polymeric stabilizers. In some embodiments, the extracted aqueous hydrogen peroxide solution is sequentially stabilized with the one or more oxidizer stable polymeric stabilizers, concentrated, and subjected to reverse osmosis. In further embodiments, the resulting hydrogen peroxide solution after reverse osmosis is again treated with the one or more oxidizer stable polymeric stabilizers. Treatment with additional oxidizer stable polymeric stabilizer after reverse osmosis can replace any polymeric stabilizer lost through reverse osmosis.

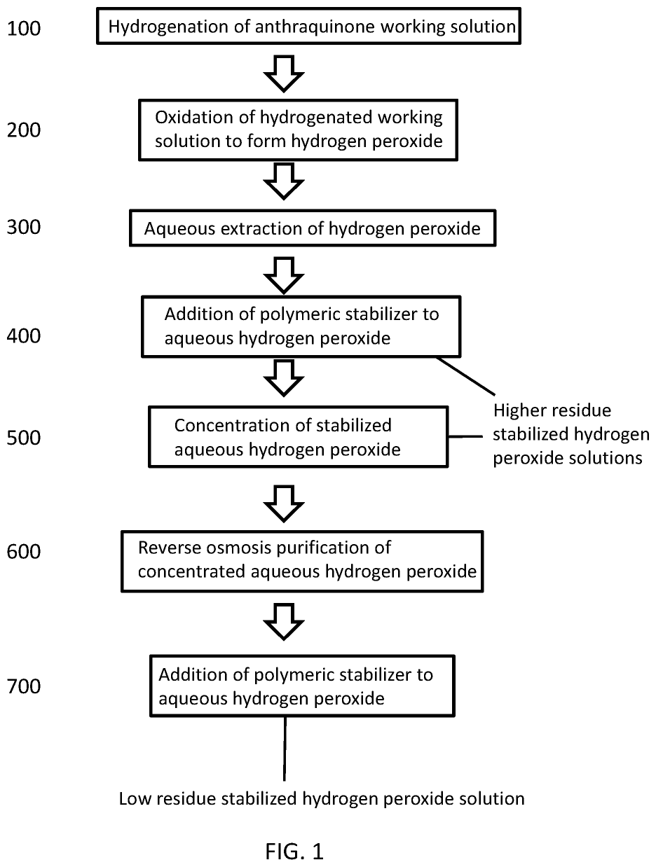

FIG. 1 illustrates a representative embodiment of a process for preparing low or higher residue stabilized hydrogen peroxide solutions. In a first step (100), an anthraquinone working solution is subjected to hydrogenation. Next, the hydrogenated working solution is subjected to oxidation (200) to form hydrogen peroxide. The hydrogen peroxide is then extracted (300) with aqueous media. Next, polymeric stabilizer is added (400) to the extracted aqueous hydrogen peroxide solutions. Optionally, the stabilized aqueous hydrogen peroxide solution is concentrated (500). Hydrogen peroxide solutions obtained from steps (400) or (500) are suitable for applications in pulp and paper bleaching. Further optionally, the solution after step (500) is subjected to purification (e.g., reverse osmosis) (600) and treated with a polymeric stabilizer(s) as described herein (700). The resultant low residue stabilized hydrogen peroxide solutions are suitable for applications in aseptic packaging and electronics.

Polymeric Stabilizer

Oxidizer stable polymeric stabilizers, as used herein, refers to polymeric stabilizers that are resistant to degradation in the presence of hydrogen peroxide and the oxidizing conditions in the anthraquinone loop process.

In some embodiments, oxidizer stable polymeric stabilizers include a phosphino polycarboxylic acid, a poly(acrylic acid), a poly(methacrylic acid), a poly(acrylamide), a poly(vinyl pyrrolidone), a poly(2-acrylamido-2-methylpropane sulfonic acid), a poly(acrylic acid:hydroxypropyl acrylate), a poly(acrylic acid:2-acrylamido-2-methylpropane sulfonic acid), a poly(acrylic acid:2-acrylamido-2-methylpropane sulfonic acid:sulfonate styrene), and a poly(acrylic acid:2-acrylamido-2-methylproppanesulfonic acid:t-butyl acrylamide), or a salt thereof. The foregoing stabilizers are described by Zuhl and Amjad in Chapter 5, “The Science and Technology of Industrial Water Treatment.” Reproduced with Permission from CRC Press/Taylor & Francis Group, a division of Informa. ISBN-978-1-42007144-3, Chap-5 (2010), which is incorporated by reference herein.

In some embodiments, an oxidizer stable polymeric stabilizer has a molecular weight from about 800 to 100,000 g/mol. In some embodiments, the oxidizer stable polymeric stabilizer has a molecular weight from about 800 to about 15,000 g/mol. In some embodiments, the oxidizer stable polymeric stabilizer has a molecular weight from about 2000 to about 15,000 g/mol.

In some embodiments, a poly(acrylic acid) stabilizer has a molecular weight less than about 10,000 g/mol. In some embodiments, a poly(acrylic acid) stabilizer has a molecular weight of from about 800 to 100,000 g/mol. In some embodiments, a poly(acrylic acid) stabilizer has a molecular weight of from about 800 to 10,000 g/mol. In some embodiments, a poly(acrylic acid) stabilizer has a molecular weight of from about 2,000 to 7,000 g/mol.

In some embodiments, a poly(methacrylic acid) stabilizer has a molecular weight of about 5,000 g/mol.

In some embodiments, a poly(acrylamide) stabilizer has a molecular weight of less than about 10,000 g/mol.

In some embodiments, a poly(2-acrylamido-2-methylpropane sulfonic acid) has a molecular weight of less than about 10,000 g/mol.

In some embodiments, a poly(acrylic acid:hydroxypropyl acrylate) has a molecular weight of about 7,000 g/mol.

In some embodiments, a poly(acrylic acid:2-acrylamido-2-methylpropane sulfonic acid) has a molecular weight of less than about 15,000 g/mol.

In some embodiments, a poly(acrylic acid:2-acrylamido-2-methylpropane sulfonic acid:sulfonate styrene) has a molecular weight of less than about 15,000 g/mol.

In some embodiments, a poly(acrylic acid:2-acrylamido-2-methylpropanesulfonic acid:t-butyl acrylamide) has a molecular weight of less than about 15,000 g/mol.

In other embodiments, the oxidizer stable polymeric stabilizers include a phosphino polycarboxylic acid and a polymer derived from one or more monomer units independently selected from

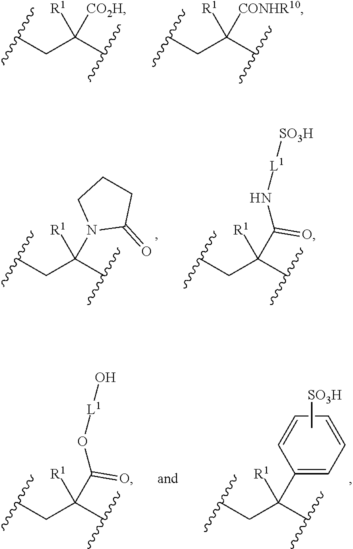

wherein R¹ and R¹⁰, at each occurrence, are independently hydrogen or C₁₋₄alkyl and L¹ is C₂₋₆alkylene.

In some embodiments, the oxidizer stable polymeric stabilizers may be: a) a phosphino polycarboxylic acid, or salt thereof, the phosphino polycarboxylic acid having a molecular weight of 1500 to 10,000 g/mol; b) a poly(acrylic acid), or a salt thereof, with molecular weight of 4000-5000 g/mol; and/or c) a polymer, or salt thereof, with molecular weight of 3000 to 15,000 g/mol, the polymer being derived from a plurality of monomer units of each of

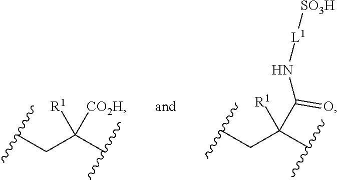

and, and optionally,

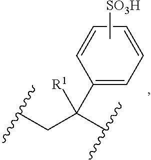

wherein R¹, at each occurrence, is independently hydrogen or C₁₋₄alkyl and L¹ is C₂₋₆alkylene.

In some embodiments, the one or more polymeric stabilizers is selected from a phosphino polycarboxylic acid, or salt thereof. The phosphino polycarboxylic acid has formula (I)

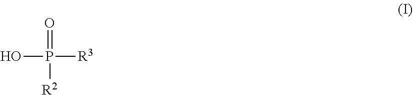

wherein R² is

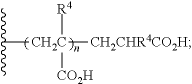

### R³ is

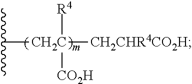

R⁴, at each occurrence, is independently hydrogen or C₁₋₄alkyl; and m and n are each independently an integer, where m+n is an integer from 30 to 60. In some embodiments, R⁴ is hydrogen. In some embodiments, the phosphino polycarboxylic acid has a molecular weight of 3300-3900 g/mol.

In some embodiments, the one or more polymeric stabilizers is selected from a poly(acrylic acid), or a salt thereof. In some embodiments, the poly(acrylic acid), or salt thereof, has a molecular weight of 4100-4900 g/mol.

In some embodiments, the one or more polymeric stabilizers is selected from a polymer, or salt thereof, with molecular weight of 3000 to 15,000 g/mol, the polymer being derived from a plurality of monomer units of each of

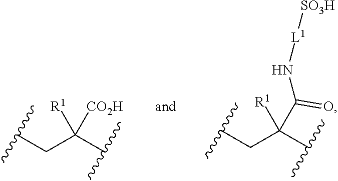

wherein R¹, at each occurrence, is independently hydrogen or C₁₋₄alkyl and L¹ is C₂₋₆alkylene. In some CO₂H embodiments, the polymer is derived from a plurality of monomer units of each of

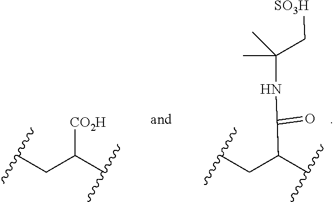

The polymeric stabilizers preferably consist of the specified monomer units.

In some embodiments, the one or more polymeric stabilizers is selected from a polymer, or salt thereof, with molecular weight of 3000 to 15,000 g/mol, the polymer being derived from a plurality of monomer units of each of

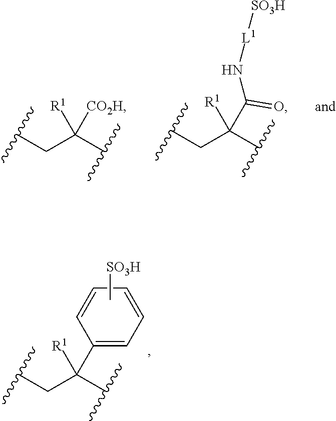

wherein R¹, at each occurrence, is independently hydrogen or C₁₋₄alkyl and L¹ is C₂₋₆alkylene. In some embodiments, the polymer is derived from a plurality of monomer units of each of

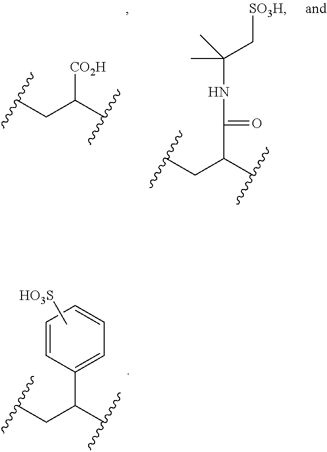

The polymeric stabilizers preferably consist of the specified monomer units.

Unless otherwise specified, as used herein a polymer molecular weight refers to a weight average molecular weight of a polymer sample measured by gel permeation chromatography (GPC).

In some embodiments, the salt of an oxidizer stable polymeric stabilizer is an alkali metal salt.

In some embodiments, the alkali metal salt is a sodium salt.

The term “alkyl” as used herein, means a straight or branched chain saturated hydrocarbon.

Representative examples of alkyl include, but are not limited to, methyl, ethyl, npropyl, isopropyl, n-butyl, sec-butyl, isobutyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkylene,” as used herein, means a divalent group derived from a straight or branched chain saturated hydrocarbon. Representative examples of alkylene include, but are not limited to, —CH₂—, —CH₂CH₂—, —CH₂CH₂CH₂—, —CH₂CH(CH₃)CH₂—, and CH₂CH(CH₃)CH(CH₃)CH₂—.

Terms such as “alkyl” and “alkylene,” may be preceded by a designation indicating the number of atoms present in the group in a particular instance (e.g., “C₁₋₄alkyl,” “C₁₋₄alkylene”). These designations are used as generally understood by those skilled in the art. For example, the representation “C” followed by a subscripted number indicates the number of carbon atoms present in the group that follows. Thus, “C₃alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

The polymeric stabilizers may be added to the about 25-40% H₂O₂ solution obtained from extraction and prior to concentration. Polymeric stabilizers may also be added after concentration at different points depending on the intended use. For example, polymeric stabilizers may be added to solutions obtained from reverse osmosis purification. Alternatively, for standard grade H₂O₂ solutions not subjected to high levels of purification, additional polymeric stabilizer may be added downstream as needed.

The polymeric stabilizers may be added to the about 25-40% H₂O₂ solution obtained from extraction and prior to concentration in an amount suitable to prevent scale formation during concentration. In some embodiments, the extracted hydrogen peroxide solution is stabilized with at least 0.1-1500 ppm of the one or more polymeric stabilizers. In some embodiments, the peroxide solution is stabilized with from 0.1-60 ppm, 0.1-50 ppm, 0.1-40 ppm, 0.1-30 ppm, 0.1-20 ppm, 0.1-10 ppm, 10-20 ppm, 20-30 ppm, 30-40 ppm, 40-50 ppm, or 50-60 ppm of the one or more polymeric stabilizers. In other embodiments, the peroxide solution is stabilized with higher concentrations of the one or more polymeric stabilizers. For example, the 25-40% hydrogen peroxide solution may be stabilized with from 50-150 ppm, 150-250 ppm, 250-350 ppm, 350-650 ppm, 600-900 ppm, 800-1200 ppm, or 1200-1600 ppm of the one or more polymeric stabilizers. In some embodiments, the one or more polymeric stabilizers are added in an amount of ≥100 ppm, ≥200 ppm, ≥300 ppm, ≥500 ppm, ≥750 ppm, ≥1000 ppm, ≥1500 ppm, or ≥2000 ppm.

Levels of polymeric stabilizer≤60 ppm are suited for aseptic packaging applications with about 35% H₂O₂ solutions. Thus, following purification of a crude H₂O₂ solution to a level suitable for aseptic packaging/food applications, polymeric stabilizers may be added in amounts that would provide ≤60 ppm polymeric stabilizer in an about 35% H₂O₂ solution. For example, a purified 70% H₂O₂ solution may be stabilized with ≤120 ppm of polymeric stabilizer for eventual twofold dilution of H₂O₂ prior to the end use. In some embodiments, a purified H₂O₂ solution is stabilized with amounts of polymeric stabilizer(s) that provides 0.1-60 ppm, 0.1-50 ppm, 0.1-40 ppm, 0.1-30 ppm, 0.1-20 ppm, 0.1-10 ppm, 10-20 ppm, 20-30 ppm, 30-40 ppm, 40-50 ppm, or 50-60 ppm of the one or more polymeric stabilizers in an about 35% H₂O₂ solution.

For concentrated standard grade H₂O₂ solutions not subjected to high level purification, additional polymeric stabilizer may be added in amounts suitable for the particular end use. In some embodiments, a standard grade hydrogen peroxide solution is stabilized with higher concentrations of the one or more polymeric stabilizers. For example, a 50% hydrogen peroxide solution may be stabilized with from 50-150 ppm, 150-250 ppm, 250-350 ppm, 350-650 ppm, 600-900 ppm, 800-1200 ppm, or 1200-1600 ppm of the one or more polymeric stabilizers. In some embodiments, the one or more polymeric stabilizers are added in an amount ≥100 ppm, ≥200 ppm, ≥300 ppm, ≥500 ppm, ≥750 ppm, ≥1000 ppm, ≥1500 ppm, or ≥2000 ppm. Higher amounts of polymeric stabilizers in a 50% standard grade hydrogen peroxide may have downstream applications in pulp and paper bleaching, bearing in mind the expected dilutions under bleaching conditions in the mill. Additional polymeric stabilizer may be added as needed prior to bleaching.

Additives and Other Solutes

The processes disclosed herein optionally include adding additives during or after hydrogen peroxide production, concentration, purification, amongst which other stabilizers. Such stabilizers may be chosen from nitric acid, phosphoric acid, benzoic acid, dipicolinic acid (DPA), from salts chosen from nitrate, phosphate, pyrophosphate, stannate, benzoate, salicylate, diethylene triamine penta (methylene phosphonate), and mixtures thereof. The salts may be ammonium or alkaline metal salts, especially ammonium or sodium salts. The stabilizer may be chosen from nitric acid, phosphoric acid, di-sodium pyrophosphate, ammonium nitrate, sodium nitrate, sodium stannate, and mixtures thereof. The stabilizer may be added in amount of from 0.1 to 200 ppm, 0.1 to 100 ppm, 0.1 to 50 ppm, 0.1 to 40 ppm, 0.1 to 30 ppm, 0.1 to 20 ppm, 0.1 to 10 ppm, 0.1 to 5 ppm. Those amounts are those based on the weight of the solution. In some embodiments, nitric acid is added after reverse osmosis.

Useful stannates include an alkali metal stannate, particularly sodium stannate (Na₂(Sn(OH)₆). Stannates further include stannic chloride, stannic oxide, stannic bromide, stannic chromate, stannic iodide, stannic sulfide, tin dichloride bis(2,4-pentanedionate), tin phthalocyanine dichloride, tin acetate, tin t-butoxide, di-n-butyl tin(IV) dichloride, tin methacrylate, tin fluoride, tin bromide, stannic phosphide, stannous chloride, stannous fluoride, stannous pyrophosphate, sodium stannate, stannous 2-ethylhexoate, stannous bromide, stannous chromate, stannous fluoride, stannous methanesulfonate, stannous oxalate, stannous oxide, stannous sulfate, stannous sulfide, barium stannate, calcium stannate, copper(II) stannate, lead stannate dihydrate, zinc stannate, sodium stannate, potassium stannate trihydrate, strontium stannate, cobalt(II) stannate dihydrate, sodium trifluorostannate, ammonium hexachlorostannate, and lithium hexafluorostannate.

In some embodiments, a stannate is not added in the production of the stabilized hydrogen peroxide solutions described herein and the solution is free of, or substantially free of, a stannate.

Other additives that may be added during the processes described herein to supplement the stability of the polymeric stabilizer include chelants. Chelants may be selected from amino tri(methylenephosphonic acid) (ATMP), 2-phosphonobutane-1,2,4-tricarboxylic acid (PBTCA), N-sulfonic amino dimethylene phosphonic acid (SADP), methylamine dimethylene phosphonic acid (MADMP), glycine dimethyl phosphonic acid (GDMP), 2-hydroxyphosphonocarboxylic acid (HPAA), polyhydric alcohol phosphate ester (PAPE), 1-hydroxyethylidene-1,1-diphosphonic acid (HEDP), 1-aminoethane-1,1-diphosphonic acid, amino tri(methylenephosphonic acid) (ATMP), ethylene diamine tetra(methylenephosphonic acid), hexamethylene diamine tetra(methylenephosphonic acid), diethylenetriamine penta(methylenephosphonic acid) (DTPMP), diethylenetriamine hexa(methylenephosphonic acid), and 1-aminoalkane-1,1-diphosphonic acids such as morpholinomethane diphosphonic acid, N,N-dimethyl aminodimethyl diphosphonic acid, aminomethyl diphosphonic acid, or a salt thereof.

In some embodiments, the aqueous hydrogen peroxide solution obtained by the processes disclosed herein has ≤30, ≤25, ≤20, ≤15, ≤10, ≤5, or ≤1 ppm of a chelating substance other than the one or more polymeric stabilizers. In some embodiments, the aqueous hydrogen peroxide solution is free of, or substantially free of, a chelating substance other than the one or more polymeric stabilizers.

In some embodiments, a phosphoric acid, or salt thereof, is added into the oxidation reaction that produces hydrogen peroxide. In some embodiments, a phosphoric acid, or salt thereof, is added to the extracted aqueous hydrogen peroxide solution. In some embodiments, the phosphoric acid, or a salt thereof, is added to the extracted aqueous hydrogen peroxide solution prior to concentrating or subjecting the solution to reverse osmosis. In some embodiments, the phosphoric acid, or salt thereof, is added concurrently with the one or more oxidizer stable polymeric stabilizers.

A phosphate salt can take the form of the simple monomeric species, or of the condensed linear polyphosphate, or cyclic polyphosphate(metaphosphate). The monomeric phosphate salts are of the general formula, MₙH_{g}PO₄, (in which q=0, 1, or 2; n=1, 2, or 3; n+q=3). Here M can be one or more monovalent cations selected from the following: Li, Na, K, NH₄, NR₄ (where R represents an alkyl chain containing 1 to 5 C atoms). The polyphosphates have the general formula, Mₙ₊₂PₙO₃ₙ₊₁ where n=2 to 8, and M can be chosen from Li, Na, K, NH₄, NR₄ where R represents an alkyl chain containing 1 to 5 C atoms). The cyclic polyphosphates have the general formula MₙPₙO₃n where n=3 to 8 and M can be chosen from Li, Na, K, NH₄, NR₄ where R represents a linear or branched alkyl group containing 1 to 5 C atoms). The above may be optionally introduced into the stabilizer system in their acid form. Exemplary phosphates include pyrophosphoric acid and metaphosphoric acid and their salts, e.g., sodium salts.

Also to be contemplated as phosphorus containing salts are organophosphonates which may be introduced as a soluble salt or as the parent acid. Compounds which may be contemplated include ethylphosphonic acid, propylphosphonic acid, butylphosphonic acid, t-butylphosphonic acid, or phenylphosphonic acid. Additionally the phosphonic acid molecules can contain other functional groups such as hydroxy or amino. These are exemplified in compounds such; as 1-hydroxyethylidene-1,1-diphosphonic acid, and poly(methyleneamino) phosphonic acids such as aminotri(methylene phosphonic acid), and diethylenetriaminepenta(methylenephosphonic acid).

In some embodiments, a phosphoric acid or salt thereof is added in an amount sufficient to stabilize any iron present. In the manufacturing process, phosphate may be present in a crude hydrogen peroxide solution of about 40% at about 50-200 ppm. Following concentration to 50-70% hydrogen peroxide, standard grade hydrogen peroxide may have about 200-300 ppm phosphate. In some embodiments, the resulting aqueous hydrogen peroxide solution has a phosphorus content expressed as PO₄³⁻ of ≤10 ppm, in some embodiments ≤5 ppm, in some embodiments ≤2 ppm. In some embodiments, the foregoing concentrations refer to solutions with a H₂O₂ concentration of about 35 weight %. For more concentrated or dilute H₂O₂ solutions, the phosphate levels will also vary proportionately.

In some embodiments, the hydrogen peroxide solutions obtained by the disclosed processes are free of, or substantially free of, stannate and/or phosphate. Thus, in some embodiments, no phosphate source is added during the process.

In some embodiments, the aqueous hydrogen peroxide solution produced by the disclosed methods consists essentially of hydrogen peroxide, water, and the polymeric stabilizer, as described herein. In other embodiments, the aqueous hydrogen peroxide solution consists essentially of hydrogen peroxide, water, a phosphate, and the polymeric stabilizer, as described herein.

Yet further stabilizers to be contemplated are free radical scavengers. In general, the free radical scavenger may be an organic chelating agent such as a salicylic acid, quinoline, pyridine-2-carboxylic acid, and mixtures thereof. Suitable aromatic chelating agents or aromatic radical scavengers include carbocyclic aromatic rings, such as the benzene or naphthalene ring, as well as heteroaromatic rings such as pyridine and quinoline. The stabilizer may also contain chelating groups, such as hydroxyl, carboxyl, phosphonate, or sulfonate. The aromatic chelating agent may be, for example, a salicylic acid. Any suitable salicylic acid may be used. Salicylic acids may include, for example, a substituted salicylic acid, such as 3-methylsalicylic acid, 4-methyl salicylic acid, 5-methyl salicylic acid, 6-rnethyl salicylic acid, 3,5-dimethyl salicylic acid, 3-ethyl salicylic acid, 3-iso-propyl salicylic acid, 3-methoxy salicylic acid, 4-methoxy salicylic acid, 5-methyoxy salicylic acid, 6-methoxy salicylic acid, 4-ethoxy salicylic acid, 5-ethyoxy salicylic acid, 2-chloro salicylic acid, 3-chlorosalicylic acid, 4-chloro salicylic acid, 5-choloro salicylic acid, 3,5-dichloro salicylic acid, 4-fluoro salicylic acid, 5-fluoro salicylic acid, 6-fluoro salicylic acid; or a mixture thereof. In a preferred embodiment, the salicylic acid is salicylic acid of the formula C₆H₄(OH)COOH. The aromatic chelating agent may be, for example, 8-hydroxy-quinoline; a substituted 8-hydroxy-quinoline, such as, 5-methyl-8-hydroxyquinoline, 5-methoxy-8-hydroxy-quinoline, 5-chloro-8-hydroxy-quinoline, 5,7-dichloro-8-hydroxy-quinoline, 8-hydroxy-quinoline-5-sulfonic acid, or a mixture thereof. The aromatic chelating agent may be, for example, a pyridine-2-carboxylic acid, such as picolinic acid (2-pyridinecarboxylic acid); dipicolinic acid (2,6-pyridinedicarboxylic acid); 6-hydroxy-picolinic acid; a substituted 6-hydroxy-picolinic acid, such as 3-methyl-6-hydroxy-picolinic acid, 3-methoxy-6-hydroxy-picolinic acid, 3-chloro-6-hydroxy-picolinic acid, or a mixture thereof. Preferred aromatic chelating agents include salicylic acid, 6-hydroxy-picolinic acid, and 8-hydroxy-quinoline. A free radical scavenger may function as both a free radical inhibitor and a chelating agent.

The aqueous hydrogen peroxide solution may also contain metal cations such as alkali metals or alkaline earth metals, for instance sodium, and/or anions such as phosphates, nitrates, etc. in low contents. The alkaline and alkaline earth metals may be present in an amount of from 1 to 200 ppm, from 20 to 30 ppm, based on the weight of the solution. The anions may be present in an amount of from 50 to 500 ppm, or from 100 to 300 ppm based on the weight of the solution. In some embodiments, nitrate may be added in an amount of about 200 ppm.

The stabilized hydrogen peroxide solutions of the invention may have low levels of transition metals and/or other inorganic components such as antimony, arsenic, cadmium, chromium, copper, iron, lead, nickel, mercury, selenium and tin. The levels of the foregoing may be ≤1 ppm. In some embodiments, tin may be present in an amount of ≤10 ppm. In some embodiments, iron may be present in an amount ≤0.1 ppm. In other embodiments, the following levels may be present: iron≤0.1 ppm; and arsenic, cadmium, lead, chromium, antimony, mercury, nickel, and selenium≤1 ppm. In other embodiments, the level of iron is ≤0.05 ppm.

In yet other embodiments, the following levels may be present: iron≤0.05 ppm; arsenic, cadmium, and lead≤0.02 ppm; chromium≤0.1 ppm; and antimony, mercury, nickel, and selenium≤1 ppm. In some embodiments, the foregoing concentrations refer to solutions with a H₂O₂ concentration of about 35 weight %, where the metal concentration will vary proportionately with the H₂O₂ concentration.

The aqueous hydrogen peroxide solution of the invention may contain organic impurities (products of degradation of the quinone shuttle, traces of diluent) and inorganic impurities (cations and anions introduced by the extraction water, as well as those already present in the mixture derived from the oxidation of the alkylanthraquinone(s)).

The aqueous hydrogen peroxide solution may thus comprise organic impurities expressed as TOC (total organic carbon concentration), defined according to ISO standard 8245. The TOC may contain organic compounds such as, for example, dimethyheptanol (DMH), diisobutylcarbinol (DiBC), 2,6-dimethyl-1,4-heptanediol (C₉H₂₀O₂), methyl cyclohexyl acetate, methyl cyclohexanol, tetrabutyl urea (TBU), trioctylphosphate (TOP), and/or degradation products of alkylated aromatic solvents such as Solvesso 150, i.e. corresponding to the product compounds oxidized on their alkyl chain. Such TOC may be at least 0.01 ppm, at least 10 ppm, at least 50 ppm, or at least 100 ppm. The TOC is usually at most 500 ppm, in many cases at most 300 ppm, values of at most 250 ppm being common. Common ranges for the TOC content are from 0.01 to 500 ppm, from 50 to 300 ppm, or from 100 to 250 ppm. The TOC may contain DiBC, methyl cyclohexyl acetate, TBU and/or TOP in an amount of from 30 to 200 ppm by weight of solution, from 50 to 150 ppm, an amount of about 100 ppm being common.

General Solution Characteristics

In some embodiments, after subjecting the aqueous hydrogen peroxide solution to reverse osmosis purification, an about 70% aqueous hydrogen peroxide solution has a residue after evaporation of ≤120 ppm, ≤80 ppm, or ≤40 ppm. Such solutions may be diluted twofold to ≤60, ≤40 or ≤20 ppm for food/aseptic packaging applications with 35% hydrogen peroxide solutions. 35% H₂O₂ solutions with a residue after evaporation of ≤60 ppm are suitable for immersion bath techniques. 35% H₂O₂ solutions with a residue after evaporation of ≤40 ppm are suitable for using spraying techniques or immersion bath techniques. Solutions with a residue after evaporation of ≤20 ppm are suitable for grades of hydrogen peroxide used for treating/sterilizing packaging materials (e.g. food packaging) using spraying techniques. For more concentrated or dilute H₂O₂ solutions, the residue after evaporation will also vary proportionately.

In some embodiments, the retentate after reverse osmosis purification or the aqueous hydrogen peroxide solution prior to purification or concentration may have a higher residue after evaporation of ≥ about 800, ≥ about 1000, ≥ about 1200, ≥ about 1400, ≥ about 1600, ≥ about 1800, or about ≥2000 ppm. Such solutions may be suitable for applications in pulp and paper bleaching.

The residue after evaporation can be determined using the following general procedure:
Clean a platinum dish of suitable size with sea sand by placing a small quantity of the sand into the dish, dampening it and then rubbing it around the dish with a soft cloth so that the surface of the dish is roughened. After each cleaning wash the platinum dish very carefully with distilled water. Add a few milliliters of distilled water to the prepared dish, then place the platinum dish into a larger flat porcelain dish containing distilled water as cooling medium. Smaller platinum dishes can be placed directly into a thermostat at 40° C.
Cover the platinum dish with a watchglass in order to avoid mistakes caused by splashing. Add the hydrogen peroxide in small portions to avoid a violent decomposition. The hydrogen peroxide decomposition samples are usually between 50-200 ml. After decomposition heat the sample using the water bath and after degassing completely remove the watchglass and rinse it off into the platinum dish. The sample is evaporated until almost dry and the residue is rinsed into a quartz glass dish. If only the evaporation residue is to be determined, this can take place directly in the platinum dish. The dish contents must however be rinsed into a quartz glass dish when the residue is to be treated further, because the presence of phosphoric acid or phosphates can damage the platinum dish. Before analysis, boil the quartz glass dish with hydrochloric acid 37% p.a., rub it with sea sand and rinse it with distilled water. Dry the dish at 105° C., calcine it, cool it in a desiccator and finally weigh it. In this dish the sample is evaporated until dryness and then dried in a drying cabinet until a constant weight is reached. After cooling in a desiccator weigh the dish with the residue.

Calculation:

Evaporation residue (mg/l)=residue found (mg)×100/volume of sample (ml)

Evaporation residue (ppm)=residue found (mg/l)/density of sample

The processes described herein provide hydrogen peroxide solutions having stability at elevated temperature for extended time periods. In some embodiments, after 16 hours at 96° C. the hydrogen peroxide concentration of the aqueous hydrogen peroxide solution is reduced by ≤ about 5 weight %. In further embodiments, after 16 hours at 96° C. the hydrogen peroxide concentration of the aqueous hydrogen peroxide solution is reduced by ≤ about 3.5 weight %. In still further embodiments, the reduction in hydrogen peroxide concentration is measured in the presence of 0.2 ppm iron, 0.3 ppm aluminum, 0.1 ppm nickel, and/or 0.1 ppm chromium. In some embodiments, the foregoing decomposition results refer to solutions with a H₂O₂ concentration of about 35 weight %. At higher H₂O₂ concentrations, and thus higher polymeric stabilizer concentrations, decomposition amounts are expected to be further reduced.

The apparent pH of the aqueous hydrogen peroxide solution according to the invention may be adjusted to the sought value by the addition of a strong mineral acid, preferably of nitric acid and/or phosphoric acid. In some embodiments, the aqueous hydrogen peroxide solution has a pH≤4. Crude solutions of hydrogen peroxide may have a pH around 3-4. Final product pH is typically around 1-4, depending on the concentration. In some embodiments, the pH is about 1-2, for example with a 70 wt. % hydrogen peroxide solution. In other embodiments, the pH is about 1-3, for example with a 50 wt. % hydrogen peroxide solution. In other embodiments, the pH is 1.5 to 3.5, for example, for a 35 wt. % hydrogen peroxide solution. In pulp and paper bleaching applications, hydrogen peroxide solutions typically have a pH between 9-13.

Selected components of exemplary polymer stabilized aqueous hydrogen peroxide solutions are shown in the following table 2:

TABLE 2

| | | Standard | Pulp | RO | Aseptic |
|---|---|---|---|---|---|
| | Crude | Grade | bleaching | Purified | grade |
| Component | ca. 40% | ca. 50% | ca. 2% | ca. 70% | ca. 35% |
| (ppm) | H₂O₂ | H₂O₂ | H₂O₂ | H₂O₂ | H₂O₂ |
| Polymeric | 0.1-1500 | 0.1-1500 | 0.1-1500 | 0.2-100 | 0.1-50 |
| stabilizer | | | | | |
| Phosphate | 50-200 | 200-300 | 8-12 | 0-10 | 0-5 |
| HNCO₃ | 0 | 85 | | 0-20 | 0-10 |
| NaSN | 0 | 85 | | 0-10 | 0-5 |
| Chelant | 0 | 40 | | 0 | 0-30 |
| Fe | 0.1-0.6 | 0.2-1 | | <0.5 | <0.25 |
| Cr | | | | <0.005 | <0.003 |
| Dry residue | | | | ≤16-120 | ≤8-60 |

### EXAMPLES

### Example 1 (Prophetic Example)

Preparation of an Aqueous Hydrogen Peroxide Solution According to the Present Invention

In a trial plant for the loop process according to the anthraquinone process for the preparation of hydrogen peroxide comprising the steps hydrogenation, oxidation, extraction, drying, and regeneration a working solution comprised of 0.11 mol/1 2-ethyl anthraquinone, 0.29 mol/1 2-ethyl tetra-hydroanthraquinone, 0.13 mol/1 2-isohexyl anthraquinone, and 0.12 mol/1 2-isohexyl tetra-hydroanthraquinone in a solvent mixture comprising 75 vol % of C9/C10 alkyl substituted aryl compounds, and 25 vol % of tris(2-ethyl hexyl) phosphate is used. In the hydrogenation step, a loop reactor is run at a hydrogen pressure of 0.35 MPa and a temperature of 58° C. Palladium black (0.5:1 g/1) is used as hydrogenation catalyst. The hydrogen peroxide equivalent in the hydrogenation was 13.0 g/l.

After the hydrogenation, a part of the hydrogenated working solution is regenerated using active aluminum oxide. Thereafter, the combined working solution is oxidized using the Laporte oxidation as described in Ullmann, supra, page 14. Thereafter, the hydrogen peroxide is extracted using deionized water. To the extraction water, 50 ppm H₃PO₄, both based on the weight of the hydrogen peroxide are added. The concentration of the extracted aqueous hydrogen peroxide solution is 41%. The working solution is dried by water evaporation in vacuum, and thereafter recycled to the hydrogenation step. The crude hydrogen peroxide solution is stabilized using 0.1 to 1500 ppm polymeric stabilizer and concentrated in vacuum by water evaporation.

### Example 2 (Stability Testing)

The stability of hydrogen peroxide solutions is very important for their safe storage and use. The stability can be measured by heating a sample and measuring the peroxide remaining. This test is conducted for 16 hours at 96° C. Mixtures of peroxides with other ingredients, especially decomposition catalysts such as Fe, Cu, Mn, Pt, Os, Ag, Al, V, Ni, Cr, will decrease the stability of hydrogen peroxide solutions.

Procedure

1. Flask preparation
1.1 Fill the flasks with 10% NaOH.
1.2 Heat the flasks at 96° C. for 60 minutes in a heating bath.
1.3 Remove the flasks from the heating bath and let them cool to room temperature.
1.4 Rinse the flasks with DIW (deionized water).
1.5 Fill the flasks with 10% HNO₃ for three hours.
1.6 Rinse the flasks thoroughly with Ultrapure water (three times).
1.7 Cover the flasks with aluminum foil.
1.8 Dry the flasks in a oven at 105° C. for one hour.
1.9 Remove the flasks from the oven and place them in a desiccator to cool to room temperature.

This cleaning must be done before each usage of the flasks. It is recommended that these flasks be dedicated to this procedure.

2. Stability test
2.1 Analyze the sample for initial concentration of H₂O₂, by using an appropriate test method depending on whether analyzing pure solutions of H₂O₂, or the sample contains organic ingredients like surfactants, fragrances, flavors, etc.
2.2 Place 50 ml of the hydrogen peroxide being tested in a 100 ml volumetric flask prepared as at section 1. Cover the flask with a condenser cap or a centrifuge tube as an alternative.
2.3 Place the covered flasks in a 96° C. (205° F.) silicone oil or glycerin bath for 16 hours. Use an appropriate way to measure the temperature during the length of test, such as a thermocouple attached to a recorder. The flask should be immersed so that the liquid level is not above the 100 ml mark. Clamps should be used to suspend the flask in the bath or lead “donuts” should be used to prevent the flasks from overturning.
2.4 After 16 hours remove the flask from the bath and let it cool to room temperature.
2.5 Mix thoroughly the solution in the flask.
2.6 Analyze again the solution for H₂O₂ concentration using the same method as in section 2.1.

Note: For accurate results, the stability test should be conducted in duplicate.

Calculations

Decomposition [%]=(Cᵢₙᵢₜᵢₐₗ−C_{final})/Cᵢₙᵢₜᵢₐₗ×100, where Cᵢₙᵢₜᵢₐₗ=initial concentration of H₂O₂, C_{final}=concentration of H₂O₂ after heating.

In general, H₂O₂ solutions which record hot stability values of over 96.5%, (decomposition less than 3.5%), will exhibit satisfactory shelf stability for at least a 12 month period under room temperature storage.

Stability Results

Tables 3 to 6 show the % hydrogen peroxide decomposition from stability testing for aqueous hydrogen peroxide solutions containing various stabilizers and/or additives. A hydrogen peroxide solution, prepared by an anthraquinone process, concentrated to 50 wt % and containing 15 ppm nitric acid was used for the experiments of table 3. Two different 50 wt % hydrogen peroxide solutions containing 15 ppm phosphoric acid and having a reduced content of organic impurities were used for the experiments of tables 4 and 5. A 49.4 wt % hydrogen peroxide solution purified by reverse osmosis was used for the experiments of table 6. In tests conducted with a metal spike, a cocktail of metals was added corresponding to the following amounts in the hydrogen peroxide solution: 0.2 ppm iron, 0.3 ppm aluminum, 0.1 ppm chromium, and 0 ppm or 0.1 ppm nickel was added prior to the start of the stability test. Aluminum was added as a solution of 1 mg/ml of Al in 0.5N HNO₃. Chromium was added as a chromium (III) solution of 1 mg/ml of Cr in 2% HCl. Iron was added as a solution of 1 mg/ml of Fe in 2-5% HNO₃.

Tables 3 to 6 include the following abbreviations.

| | |
|---|---|
| NaHPP | Sodium hydrogen pyrophosphate |
| NaSN | Sodium stannate |
| A1000 | Acumer ™ 1000 (Dow): a polyacrylic acid with sodium |
| | hydrogen sulfite giving a pH of 3.2-4.0 and having a |
| | molecular weight of 4100-4900 g/mol. |
| A445 | ACUSOL ™ 445 (Rohm and Haas): a partially neutralized |
| | homopolymer of acrylic acid giving a pH of 3.7 and having |
| | Mw of 4500 g/mol. |
| A445N | ACUSOL ™ 445N (Rohm and Haas): a neutralized homo- |
| | polymer of acrylic acid giving a pH of 6.9 and having Mw |
| | of 4500 g/mol. |
| K-781 | Carbosperse ™ K-781 Acrylate Terpolymer (Lubrizol): a |
| | partially neutralized acrylic terpolymer of acrylic acid, |
| | 2-acrylamido-2-methylpropane sulfonic acid and sulfonated |
| | styrene giving a pH of 2.2-3.2 and having a molecular weight |
| | less than 10,000 g/mol. |
| A4161 | Acumer ™ 4161 (Rohm and Haas): a phosphinopolycarboxylic |
| | acid giving a pH of 3.0-3.5 and having a molecular weight of |
| | 3300-3900 g/mol measured by GPC of the acid form. |
| P9110 | Dequest ® P9110 (Italmatch): a phosphinopolycarboxylic acid |
| | giving a pH of 3.5-5 and having Mw of 4500-5500 g/mol. |
| P9500 | Dequest ® P9500 (Italmatch): a partially neutralized terpolymer |
| | of acrylic acid, 2-acrylamido-2-methylpropanesulfonic acid and |
| | sodium phosphinite giving a pH of 1.5-3.0. |
| X | Metal spike providing 0.1 ppm Nickel |
| XX | Metal spike providing no Nickel |

TABLE 3

| Stabilizer added | | | | | | |
|---|---|---|---|---|---|---|
| NaHPP | NaSN | A1000 | DTPMP | ATMP | Metal | Decomposition |
| (ppm) | (ppm) | (ppm) | (ppm) | (ppm) | Spike | result |
| 2.5 | 5 | 0 | 0 | 0 | | 0.45% |
| 2.5 | 5 | 2.5 | 0 | 0 | | 0.77% |
| 2.5 | 5 | 2.5 | 2.5 | 0 | | 1.02% |
| 2.5 | 5 | 2.5 | 0 | 2.5 | | 1.08% |
| 2.5 | 5 | 0 | 0 | 0 | X | 9.30% |
| 2.5 | 5 | 2.5 | 0 | 0 | X | 31.40% |
| 2.5 | 5 | 2.5 | 2.5 | 0 | X | 9.20% |
| 2.5 | 5 | 5 | 2.5 | 0 | X | 7.20% |

TABLE 4

| Stabilizer added | | | | | | | | |
|---|---|---|---|---|---|---|---|---|
| NaHPP | NaSN | A1000 | A445 | DTPMP | ATMP | K-781 | Metal | Decomposition |
| (ppm) | (ppm) | (ppm) | (ppm) | (ppm) | (ppm) | (ppm) | Spike | result |
| 2.5 | 5 | 0 | | 0 | 0 | 0 | | 1.61% |
| 2.5 | 5 | 2.5 | | 0 | 0 | 0 | | 2.54% |
| 2.5 | 5 | 2.5 | | 2.5 | 0 | 0 | | 0.85% |
| 2.5 | 2.5 | 2.5 | | 0 | 2.5 | 0 | | 1.97% |
| 2.5 | 2.5 | 0 | | 0 | 0 | 10 | | 0.91% |
| 2.5 | 5 | 0 | | 0 | 0 | 0 | X | 3.90% |
| 2.5 | 5 | 2.5 | | 2.5 | 0 | 0 | X | 5.40% |
| 2.5 | 5 | 5 | | 2.5 | 0 | 0 | X | 5.60% |
| 2.5 | 5 | 2.5 | | 5 | 0 | 0 | X | 7.60% |
| 2.5 | 5 | 0 | | 5 | 0 | 0 | XX | 7.06% |
| 2.5 | 5 | 0 | | 10 | 0 | 0 | XX | 1.67% |
| 2.5 | 5 | 5 | | 5 | 0 | 0 | XX | 2.96% |
| 2.5 | 5 | 5 | | 2.5 | 0 | 0 | XX | 5.60% |
| 2.5 | 5 | 0 | 5 | 5 | 0 | 0 | XX | 2.70% |
| 2.5 | 5 | 0 | 10 | 0 | 0 | 0 | XX | 5.10% |

TABLE 5

| Stabilizer added | | | | | |
|---|---|---|---|---|---|
| NaHPP | NaSN | A445N | A4161 | Metal | Decomposition |
| (ppm) | (ppm) | (ppm) | (ppm) | Spike | result |
| 2.5 | 5 | 50 | 0 | X | 3.62% |
| 2.5 | 5 | 25 | 0 | X | 4.16% |
| 2.5 | 5 | 12.5 | 0 | X | 4.42% |
| 2.5 | 5 | 0 | 50 | X | 2.88% |
| 2.5 | 5 | 0 | 25 | X | 1.88% |
| 2.5 | 5 | 0 | 12.5 | X | 1.88% |

TABLE 6

| Stabilizer added | | | | | | |
|---|---|---|---|---|---|---|
| NaHPP | NaSN | A4161 | P9110 | P9500 | K-781 | Decomposition |
| (ppm) | (ppm) | (ppm) | (ppm) | (ppm) | (ppm) | result |
| 0 | 0 | 0 | 0 | 0 | 0 | 57.3% |
| 0 | 0 | 10 | 0 | 0 | 0 | 1.4% |
| 0 | 0 | 20 | 0 | 0 | 0 | 1.3% |
| 0 | 0 | 100 | 0 | 0 | 0 | 0.5% |
| 0 | 0 | 200 | 0 | 0 | 0 | 1.1% |
| 0 | 0 | 0 | 20 | 0 | 0 | 1.7% |
| 0 | 0 | 0 | 0 | 20 | 0 | 1.8% |
| 0 | 0 | 0 | 0 | 0 | 100 | 0.8% |

### Example 3 (Adding Stabilizer Before Concentrating)

A 45 wt %⁰ crude hydrogen peroxide from the extraction step of an anthraquinone process was passed to a buffer tank where sodium hydrogen pyrophosphate was added to provide a concentration of 22 ppm. The hydrogen peroxide from this buffer tank was then concentrated in a continuous distillation at a pressure of about 100 mbar to 70 wt %. The concentrated peroxide was tested for decomposition by heating samples in a water bath at 96° C., as described in example 2, in a flask with a gas tight connection to a 100 ml gas burette graduated at 0.2 ml. After an initial period of 30 min, gas development was followed for a 5 h period and the decomposition over a 16 h period was calculated from the following formula:

% Loss={V_{g}*[273/(273+t)]*[(P−p)/1013]*16*100}/{V₁*D*(% H₂O₂/100)*(16/34)*(22,400/32)}

where V_{g} is the gas evolution rate in ml/h, t is the temperature in ° C. at which gas was collected, P is the atmospheric pressure in mbar and p is the pressure of water vapor at temperature t in mbar, V₁ is the volume of the tested hydrogen peroxide sample in ml, D is the density of the sample in g/ml and % H₂O₂ is the concentration of the sample in wt %.

Decomposition of the concentrated peroxide produced by the distillation unit increased over a 4-week period from an initial level of about 0.7% to a level of about 1.2%. Acumer™ 4161 was then added to the buffer tank in addition to the sodium hydrogen pyrophosphate at a level of 10 ppm for 6 days, followed by 5 ppm for 7 days and 20 ppm for a further 6 days. Soon after addition of the polymeric stabilizer was started, turbidity in the distillation column bottoms caused by small gas bubbles decreased visibly and the pressure at the column top decreased, indicating reduced peroxide decomposition within the distillation unit. Decomposition of the concentrated peroxide product decreased over a 7-day period to about 0.7% and remained stable at this level for the rest of the trial.

It is understood that the foregoing detailed description and accompanying examples are merely illustrative and are not to be taken as limitations upon the scope of the invention, which is defined solely by the appended claims and their equivalents. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the invention are set out in the following numbered clauses:

Clause 1. A process for the preparation of a hydrogen peroxide solution comprising:
i) hydrogenating a working solution comprising an organic solvent and one or more active anthraquinone compounds;
ii) oxidizing the hydrogenated working solution to form hydrogen peroxide,
iii) extracting the hydrogen peroxide with water, and
iv) stabilizing the extracted aqueous hydrogen peroxide solution with one or more oxidizer stable polymeric stabilizers.

Clause 2. The process of clause 1, wherein the oxidizer stable polymeric stabilizer is a phosphino polycarboxylic acid or a salt thereof.

Clause 3. The process of clause 2, wherein the phosphino polycarboxylic acid has a molecular weight of 1500 to 10,000 g/mol and preferably of 3300 to 3900 g/mol.

Clause 4. The process of clause 2, wherein the phosphino polycarboxylic acid has formula (I):

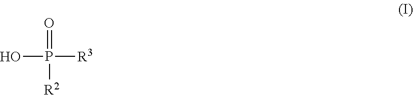

wherein
R² is

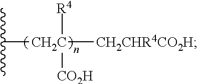

R³ is

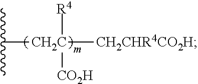

R⁴, at each occurrence, is independently hydrogen or C₁₋₄alkyl; and m and n are each independently an integer, where m+n is an integer from 30 to 60.

Clause 5. The process of clause 4, wherein R⁴ is hydrogen.

Clause 6. The process of clause 1, wherein the one or more oxidizer stable polymeric stabilizers are selected from polymers derived from one or more monomer units independently selected from

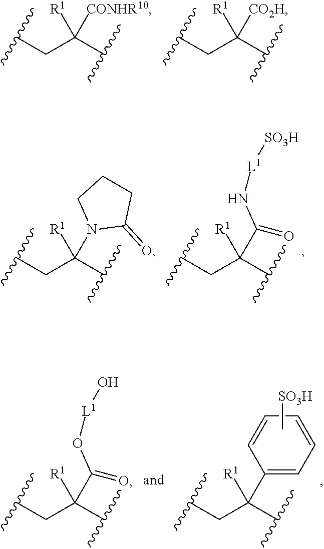

wherein R¹ and R¹⁰, at each occurrence, are independently hydrogen or C₁₋₄ alkyl and L¹ is C₂₋₆ alkylene.

Clause 7. The process of clause 6, wherein the oxidizer stable polymeric stabilizer is a polymer, or salt thereof, with molecular weight of 3000 to 15,000 g/mol, the polymer being derived from a plurality of monomer units of each of

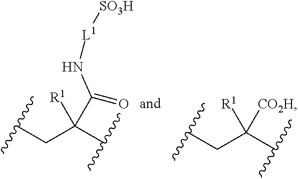

and optionally

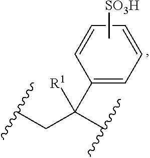

wherein R¹, at each occurrence, is independently hydrogen or C₁₋₄alkyl and L¹ is C₂₋₆alkylene.

Clause 8. The process of clause 7, wherein the polymer is derived from a plurality of monomer units of each of

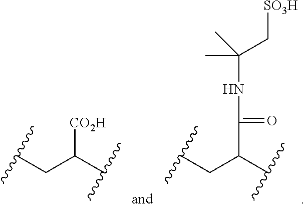

Clause 9. The process of clause 7, wherein the polymer is derived from a plurality of monomer units of each of

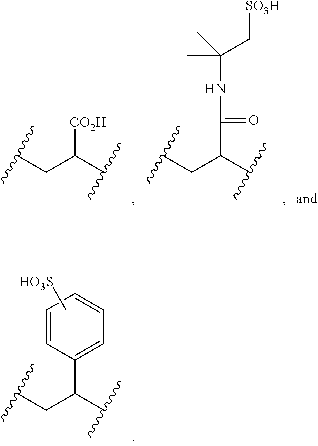

Clause 10. The process of clause 6, wherein the one or more oxidizer stable polymeric stabilizers are selected from a poly(acrylic acid), a poly(methacrylic acid), a poly(acrylamide), a poly(vinyl pyrrolidone), a poly(2-acrylamido-2-methylpropane sulfonic acid), a poly(acrylic acid: hydroxypropyl acrylate), and a poly(acrylic acid:2-acrylamido-2-methylpropanesulfonic acid: t-butyl acrylamide), or a salt thereof.

Clause 11. The process of clause 10, wherein the one or more polymeric stabilizers is poly(acrylic acid), or a salt thereof, having a molecular weight of 4100-4900 g/mol.

Clause 12. The process of any one of clauses 1-11, further comprising concentrating the aqueous hydrogen peroxide solution to a concentration of hydrogen peroxide of at least 50% by weight based on the weight of the hydrogen peroxide solution.

Clause 13. The process of clause 12, comprising concentrating the aqueous hydrogen peroxide solution to a concentration of hydrogen peroxide of about 70 weight %.

Clause 14. The process of any one of clauses 1-13, further comprising purifying the aqueous hydrogen peroxide solution by subjecting it to one or more of washing with an organic solvent, reverse osmosis, microfiltration, ultrafiltration, nanofiltration, ion exchange resin treatment, and nonionic absorber resin treatment.

Clause 15. The process of clause 14 comprising subjecting the aqueous hydrogen peroxide solution to reverse osmosis.

Clause 16. The process of clause 15 comprising subjecting the aqueous hydrogen peroxide solution to reverse osmosis followed by stabilizing with the one or more oxidizer stable polymeric stabilizers.

Clause 17. The process of clause 15 or 16, wherein the extracted aqueous hydrogen peroxide solution is sequentially stabilized with the one or more oxidizer stable polymeric stabilizers, concentrated, and subjected to reverse osmosis.

Clause 18. The process of any of clauses 1-17 further comprising adding a phosphoric acid, or salt thereof, to the extracted aqueous hydrogen peroxide solution.

Clause 19. The process of clause 18, wherein a phosphoric acid, or a salt thereof, is added to the extracted aqueous hydrogen peroxide solution prior to concentrating or subjecting the solution to reverse osmosis.

Clause 20. The process of clause 18 or 19, wherein the phosphoric acid, or salt thereof, is added concurrently with the one or more oxidizer stable polymeric stabilizers.

1. A process for the preparation of a hydrogen peroxide solution comprising:
i) hydrogenating a working solution comprising an organic solvent and one or more active anthraquinone compounds;
ii) oxidizing the hydrogenated working solution to form hydrogen peroxide,
iii) extracting the hydrogen peroxide with water, and
iv) stabilizing the extracted aqueous hydrogen peroxide solution with one or more oxidizer stable polymeric stabilizers.

2. The process of claim 1, wherein the oxidizer stable polymeric stabilizer is a phosphino polycarboxylic acid or a salt thereof.

3. The process of claim 2, wherein the phosphino polycarboxylic acid has a molecular weight of 1500 to 10,000 g/mol and preferably of 3300 to 3900 g/mol.

4. The process of claim 2, wherein the phosphino polycarboxylic acid has formula (I): 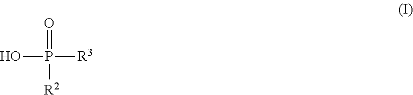
wherein
R² is 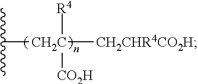
R³ is 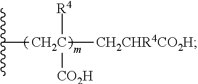
R⁴, at each occurrence, is independently hydrogen or C₁₋₄alkyl; and
m and n are each independently an integer, where m+n is an integer from 30 to 60.

5. The process of claim 4, wherein R⁴ is hydrogen.

6. The process of claim 1, wherein the one or more oxidizer stable polymeric stabilizers are selected from polymers derived from one or more monomer units
independently selected from 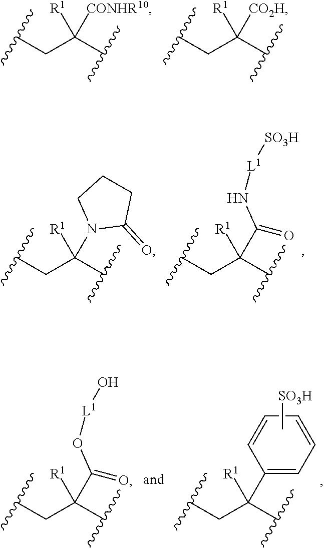
wherein R¹ and R¹⁰, at each occurrence, are independently hydrogen or C₁₋₄ alkyl and L¹ is C₂₋₆ alkylene.

7. The process of claim 6, wherein the oxidizer stable polymeric stabilizer is a polymer, or salt thereof, with molecular weight of 3000 to 15,000 g/mol, the polymer being derived from a plurality of monomer units of each of 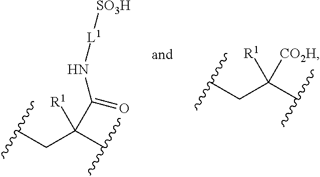
and optionally 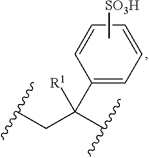
wherein R¹, at each occurrence, is independently hydrogen or C₁₋₄alkyl and L¹ is C₂₋₆alkylene.

8. The process of claim 7, wherein the polymer is derived from a plurality of monomer units of each of

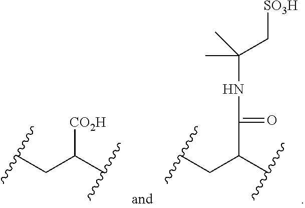

9. The process of claim 7, wherein the polymer is derived from a plurality of monomer units of each of

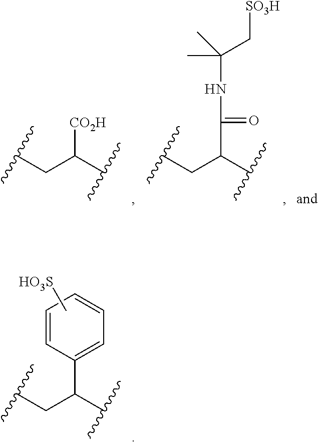

10. The process of claim 6, wherein the one or more oxidizer stable polymeric stabilizers are selected from a poly(acrylic acid), a poly(methacrylic acid), a poly(acrylamide), a poly(vinyl pyrrolidone), a poly(2-acrylamido-2-methylpropane sulfonic acid), a poly(acrylic acid:hydroxypropyl acrylate), and a poly(acrylic acid:2-acrylamido-2-methylpropanesulfonic acid:t-butyl acrylamide), or a salt thereof.

11. The process of claim 10, wherein the one or more polymeric stabilizers is poly(acrylic acid), or a salt thereof, having a molecular weight of 4100-4900 g/mol.

12. The process of claim 1, further comprising concentrating the aqueous hydrogen peroxide solution to a concentration of hydrogen peroxide of at least 50% by weight based on the weight of the hydrogen peroxide solution.

13. The process of claim 12, comprising concentrating the aqueous hydrogen peroxide solution to a concentration of hydrogen peroxide of about 70 weight %.

14. The process of claim 1, further comprising purifying the aqueous hydrogen peroxide solution by subjecting it to one or more of washing with an organic solvent, reverse osmosis, microfiltration, ultrafiltration, nanofiltration, ion exchange resin treatment, and nonionic absorber resin treatment.

15. The process of claim 14 comprising subjecting the aqueous hydrogen peroxide solution to reverse osmosis.

16. The process of claim 15 comprising subjecting the aqueous hydrogen peroxide solution to reverse osmosis followed by stabilizing with the one or more oxidizer stable polymeric stabilizers.

17. The process of claim 15, wherein the extracted aqueous hydrogen peroxide solution is sequentially stabilized with the one or more oxidizer stable polymeric stabilizers, concentrated, and subjected to reverse osmosis.

18. The process of claim 1 further comprising adding a phosphoric acid, or salt thereof, to the extracted aqueous hydrogen peroxide solution.

19. The process of claim 18, wherein a phosphoric acid, or a salt thereof, is added to the extracted aqueous hydrogen peroxide solution prior to concentrating or subjecting the solution to reverse osmosis.

20. The process of claim 18, wherein the phosphoric acid, or salt thereof, is added concurrently with the one or more oxidizer stable polymeric stabilizers.
